(19) United States
(12) Patent Application Publication
(10) Pub. No.: US 2016/0148447 A1
(43) Pub. Date: May 26, 2016

(54) METHOD, SYSTEM AND COMPUTER-READABLE RECORDING MEDIUM FOR MANAGING ABNORMAL STATE OF VEHICLE

(71) Applicant: Hyundai Motor Company, Seoul (KR)

(72) Inventor: Sung Hwan Moon, Seoul (KR)

(21) Appl. No.: 14/810,696

(22) Filed: Jul. 28, 2015

(30) Foreign Application Priority Data
Nov. 24, 2014 (KR) 10-2014-0164242

(51) Int. Cl. G07C 5/08; G07C 5/00

(52) U.S. Cl. CPC G07C 5/0841; G07C 5/008

(57) ABSTRACT

A vehicle customer relationship management system includes: a collection cycle setting module configured to set a collection cycle with respect to first vehicle data generated by a vehicle terminal; a vehicle data collection module configured to collect the generated first vehicle data via at least one telematics service system according to the set collection cycle; an abnormal condition setting module configured to set an abnormal condition with respect to the collected first vehicle data; a collection cycle change module configured to change the set collection cycle when the set abnormal condition is detected from the collected first vehicle data; and an abnormal vehicle data collection module configured to collect second vehicle data from the vehicle terminal or the at least one telematics service system based on the changed collection cycle.

### CROSS-REFERENCE TO RELATED APPLICATION

This application claims priority to and the benefit of Korean Patent Application No. 10-2014-0164242, filed on Nov. 24, 2014 which is hereby incorporated by reference as if fully set forth herein.

### BACKGROUND OF THE DISCLOSURE

1. Technical Field

The present disclosure relates generally to a method, system and computer-readable recording medium for managing an abnormal state of a vehicle, and more particularly, to a method, system and computer-readable recording medium for managing an abnormal state of a vehicle, which is capable of selectively extracting and intensively analyzing vehicle data having an abnormal state from a vast amount of vehicle data and handling the abnormal state.

2. Discussion of the Related Art

Telematics is a compound word of telecommunication and informatics and refers to a combination of technologies relating to vehicles and computers and/or mobile communication. A variety of applications utilize telematics, such as safety services based on position information, productivity improvement services via provision of an office environment, and personalized services such as banking, reservation making or product purchase based on mobile communication and Internet technology. Representative examples of vehicular-based services utilizing telematics relate to navigation, real-time traffic information provision, emergency rescue service, and entertainment.

Recently, breakdown inspection and diagnosis techniques in vehicles have been researched. In most vehicles, there are several electronic control units (ECUs) installed therein, such as an engine ECU for controlling operation of an engine based on signals sensed by various sensors, an automatic transmission ECU (ATM ECU) for controlling an operation of an automatic transmission, and an anti-lock brake system (ABS) ECU for controlling an operation of a brake. Since each ECU has a self-diagnosis function, the ECU receives sensed signals from various sensors attached to devices, stores vehicle data (also referred to as “vehicle big data”) indicating the states of the devices, and sends the stored vehicle data to an external system (e.g., a telematics service system (TMS) and/or a vehicle customer relationship management (VCRM)) using various methods. However, a conventional TMS and VCRM can collect a vast amount of vehicle data but cannot easily extract an abnormal state generated in a specific device from the data.

### SUMMARY OF THE DISCLOSURE

Accordingly, the present disclosure is directed to a method, system and computer-readable recording medium for managing an abnormal state of a vehicle that substantially obviate one or more problems due to limitations and disadvantages of the related art.

An object of the present disclosure is to provide a method, system and computer-readable recording medium for managing an abnormal state of a vehicle, which is capable of selectively extracting and intensively analyzing vehicle data having an abnormal state from a vast amount of vehicle data and handling the abnormal state. Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims herein as well as the appended drawings.

According to embodiments of the present disclosure, a vehicle customer relationship management system includes: a collection cycle setting module configured to set a collection cycle with respect to first vehicle data generated by a vehicle terminal; a vehicle data collection module configured to collect the generated first vehicle data via at least one telematics service system according to the set collection cycle; an abnormal condition setting module configured to set an abnormal condition with respect to the collected first vehicle data; a collection cycle change module configured to change the set collection cycle when the set abnormal condition is detected from the collected first vehicle data; and an abnormal vehicle data collection module configured to collect second vehicle data from the vehicle terminal or the at least one telematics service system based on the changed collection cycle.

The vehicle customer relationship management system may further include a vehicle abnormality notification module configured to analyze the collected second vehicle data and transmit the analyzed data to a manager terminal or a user terminal in the form of a notification message when vehicle abnormality continues.

The vehicle customer relationship management system may further include a resolution setting module configured to set the changed collection cycle and a resolution of the second vehicle data to be greater than an unchanged collection cycle and a resolution of the first vehicle data.

The vehicle abnormality notification module may be further configured to generate the notification message based on the set resolution.

The first vehicle data may be binary data changed from measured data.

Furthermore, according to embodiments of the present disclosure, a method of managing an abnormal state of vehicle data collected in a vehicle customer relationship management system includes: (a) a collection cycle setting module setting a collection cycle with respect to first vehicle data generated by a vehicle terminal, (b) a vehicle data collection module collecting the generated first vehicle data via at least one telematics service system based on the set collection cycle, (c) an abnormal condition setting module setting an abnormal condition with respect to the collected first vehicle data, (d) a collection cycle change module changing the set collection cycle when the set abnormal condition is detected from the first vehicle data, and (e) an abnormal vehicle data collection module collecting second vehicle data from the vehicle terminal or the at least one telematics service system based on the changed collection cycle.

The method may further include (f) a vehicle abnormality notification module analyzing the collected second vehicle data and transmitting the analyzed result to a manager terminal or a user terminal in the form of a notification message when vehicle abnormality continues.

The method may further include (g) a resolution setting module setting the changed collection cycle and resolution of the second vehicle data to be greater than an unchanged collection cycle and resolution of the first vehicle data.

The (f) step may include the vehicle abnormality notification module sending the notification message generated according to the resolution set by the resolution setting module to the manager terminal or the user terminal.

The first vehicle data may be binary data changed from measured data.

Furthermore, according to embodiments of the present disclosure, a telematics service system includes: a collection cycle reception module configured to receive a collection cycle signal set with respect to first vehicle data generated by a vehicle terminal from a vehicle customer relationship management (VCRM) system, a vehicle data reception module configured to receive the generated first vehicle data from the vehicle terminal in correspondence with the set collection cycle signal, a change collection cycle reception module configured to transmit the received first vehicle data to the VCRM system and receive a change collection signal changed in correspondence with an abnormal condition generated in a first vehicle from the VCRM system, and an abnormal vehicle data transmission module configured to acquire second vehicle data by receiving the second vehicle data from the vehicle terminal in correspondence with the change collection signal or extracting the second vehicle data from the first vehicle data and transmit the second vehicle data to the VCRM system.

The second vehicle data may be binary data selected and changed from the first vehicle data.

The vehicle data reception module may be further configured to receive the first vehicle data from the vehicle terminal over a wireless network when connected with the vehicle terminal over the wireless network.

The abnormal vehicle data transmission module may be further configured to receive the second vehicle data from the vehicle terminal over the wireless network when connected with the vehicle terminal over the wireless network.

Furthermore, according to embodiments of the present disclosure, a method of managing an abnormal state of vehicle data collected in a telematics service system includes: (a) a collection cycle reception module receiving a collection cycle signal set with respect to first vehicle data generated by a vehicle terminal from a vehicle customer relationship management (VCRM) system, (b) a vehicle data reception module receiving the generated first vehicle data from the vehicle terminal in correspondence with the set collection cycle signal, (c) a change collection cycle reception module transmitting the received first vehicle data to the VCRM system and receiving a change collection signal changed in correspondence with an abnormal condition generated in a first vehicle from the VCRM system, and (d) an abnormal vehicle data transmission module acquiring second vehicle data by receiving the second vehicle data from the vehicle terminal in correspondence with the change collection signal or extracting the second vehicle data from the first vehicle data and transmitting the second vehicle data to the VCRM system.

Furthermore, according to embodiments of the present disclosure, a system for managing an abnormal state of a vehicle includes: a telematics service system configured to collect first vehicle data generated by a vehicle terminal based on a predetermined collection cycle, and a vehicle customer relationship management system configured to set the collection cycle, receive the collected first vehicle data from the telematics service system, set an abnormal condition with respect to the received first vehicle data, and change the set collection cycle.

When the vehicle customer relationship management system transmits the changed collection cycle to the telematics service system, the telematics service system may be further configured to collect second vehicle data extracted from the first vehicle data in correspondence with the changed collection cycle and transmit the second vehicle data to the vehicle customer relationship management system.

The vehicle customer relationship management system may be further configured to analyze the collected second vehicle data and transmit the analyzed data to a manager terminal or a user terminal in the form of a notification message when vehicle abnormality continues.

The vehicle customer relationship management system may be further configured to set the changed collection cycle and a resolution of the second vehicle data to be greater than an unchanged collection cycle and a resolution of the first vehicle data.

The vehicle customer relationship management system may be further configured to generate the notification message based on the set resolution.

The telematics service system may be further configured to receive the first vehicle data from the vehicle terminal over a wireless network when connected with the vehicle terminal over the wireless network.

The telematics service system may be further configured to receive the second vehicle data from the vehicle terminal over the wireless network when connected with the vehicle terminal over the wireless network.

The first vehicle data is binary data changed from measured data.

Furthermore, according to embodiments of the present disclosure, a method of managing an abnormal state of a vehicle in a system for managing an abnormal state of a vehicle includes (a) a telematics service system collecting first vehicle data generated by a vehicle terminal based on a predetermined collection cycle, and (b) a vehicle customer relationship management system setting the collection cycle, receiving the first vehicle data from the telematics service system, setting an abnormal condition with respect to the received first vehicle data, and changing the set collection cycle.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram showing a system 100 for managing an abnormal state of a vehicle according to a first embodiment of the present disclosure.

FIG. 2 is a flowchart illustrating a method 5100 of managing an abnormal state of a vehicle in a system 100 for managing an abnormal state of a vehicle according to a second embodiment of the present disclosure.

FIG. 3 is a diagram showing the configuration of a vehicle customer relationship management system 130 according to a third embodiment of the present disclosure in detail.

FIG. 4 is a flowchart illustrating a method 5200 of managing an abnormal state of a vehicle in a vehicle customer relationship management system 130 according to a fourth embodiment of the present disclosure.

FIG. 5 is a diagram showing the configuration of a telematics service system 120 according to a fifth embodiment of the present disclosure in detail.

FIG. 6 is a flowchart illustrating a method 5300 of managing an abnormal state of a vehicle in a telematics service system 120 according to a sixth embodiment of the present disclosure.

### DETAILED DESCRIPTION OF THE EMBODIMENTS

Hereinafter, the embodiments of the present disclosure will be described in detail with reference to the accompanying drawings so as to be easily implemented by those skilled in the art. It is noted that reference numerals are used to designate identical or similar elements throughout the several views.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by modules including at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

### First Embodiment

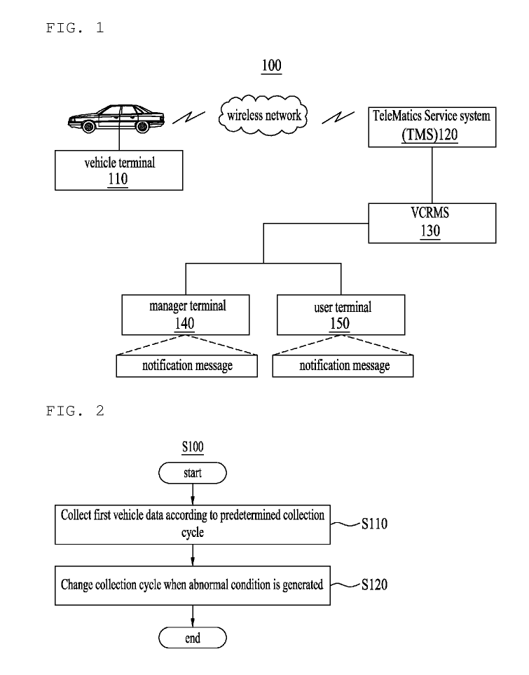

FIG. 1 is a diagram showing a system 100 for managing an abnormal state of a vehicle according to a first embodiment of the present disclosure.

As shown in FIG. 1, the system 100 for managing the abnormal state of the vehicle according to the first embodiment of the present disclosure includes a vehicle terminal 110, a telematics service system 120 and a vehicle customer relationship management system 130.

First, the vehicle terminal 110 according to the present disclosure includes a plurality of electronic control units (ECUs) such as an engine ECU mounted in a vehicle, an automatic transmission ECU (ATM ECU) for controlling operation of an automatic transmission, and an anti-lock brake system (ABS) ECU for controlling operation of a brake. Such an ECU may include a plurality of sensors. Using a sensor or a measurement device, data measured from a device is sensed. Such measured data is referred to as first vehicle data.

Next, the telematics service system 120 according to the present disclosure collects first vehicle data generated by the vehicle terminal 110 according to a predetermined collection cycle. A plurality of telematics service systems 120 may be included. Accordingly, the telematics service system 120 of each vehicle collects first vehicle data from the vehicle terminal 110 mounted in the managed vehicle.

The collected first vehicle data may be binary data changed for increasing transmission efficiency. That is, the telematics service system 120 according to the present disclosure receives the first vehicle data having the changed binary data from the vehicle terminal 110, when the vehicle data measured by the vehicle terminal 110 is changed into binary data.

The vehicle customer relationship management system 130 according to the present disclosure may set and send the collection cycle to the telematics service system 120 and then receive the first vehicle data including the binary data from the telematics service system 120. In order to extract abnormality from the received first vehicle data, the vehicle customer relationship management system 130 according to the present disclosure sets an abnormal condition with respect to the received first vehicle data and changes the predetermined collection cycle according to the abnormal condition when the abnormal condition is detected from the first vehicle data.

The changed collection cycle is referred to “change collection cycle” and means a cycle for extracting specific vehicle data necessary to determine abnormality such as vehicle malfunction. The change collection cycle is transmitted to the telematics service system 120.

The telematics service system 120 according to the present disclosure collects second vehicle data extracted from the first vehicle data in correspondence with the change collection cycle received from the vehicle customer relationship system 130. The collected second vehicle data may be transmitted to the vehicle customer relationship management system 130. The collected second vehicle data may be binary data changed for increasing transmission efficiency, similarly to the first vehicle data.

The vehicle customer relationship management system 130 according to the present disclosure analyzes the second vehicle data received from the telematics service system 120 and signals the analyzed result to a manager terminal 140 and/or a user terminal 150 when vehicle abnormality continues. The analyzed result is preferably signaled in the form of a notification message.

The vehicle customer relationship management system 130 according to the present disclosure may set the changed collection cycle and the resolution of the collected second vehicle data to be greater than the unchanged collection cycle and the resolution of the first vehicle data. Preferably, the changed collection cycle and the resolution of the collected second vehicle data may be set to be greater than the unchanged collection cycle and the resolution of the first vehicle data. If the resolution of the vehicle data is changed, abnormality can be easily detected. The notification message generated according to the changed collection cycle and the resolution of the second vehicle data may be immediately transmitted to the manager terminal 140 and/or the user terminal 150.

The telematics service system 120 according to the present disclosure may receive the first vehicle data from the vehicle terminal 110 via a wireless network, when being connected with the vehicle terminal 100 over the wireless network. The wireless network may be one of various communication networks such as a mobile communication network and a local area network.

The telematics service system 120 may receive the second vehicle data from the vehicle terminal 110 over the wireless network when being connected with the vehicle terminal 100 over the wireless network. However, the second vehicle data is not received from the vehicle terminal 100 but is preferably extracted from the pre-collected first vehicle data in correspondence with the change collection cycle.

In the present embodiment, the collection cycle is set and is changed according to the abnormal condition if abnormality is detected upon collecting the vehicle data, vehicle data corresponding to abnormality is intensively collected, and abnormality is intensively analyzed, such that abnormality is more accurately detected from a vast amount of vehicle data and is signaled in an alarm form, thereby preventing vehicle accidents.

### Second Embodiment

FIG. 2 is a flowchart illustrating a method 5100 of managing an abnormal state of a vehicle in a system 100 for managing an abnormal state of a vehicle according to a second embodiment of the present disclosure.

Referring to FIG. 2, the method 5100 of managing the abnormal state of the vehicle in the system 100 for managing the abnormal state of the vehicle according to a second embodiment of the present disclosure includes steps S110 and S120 in order to manage the abnormal state of the vehicle.

First, in step S110 according to the present disclosure, the telematics service system 120 collects the first vehicle data generated by the vehicle terminal 110 according to the predetermined collection cycle. The collected first vehicle data may be binary data changed for increasing transmission efficiency. That is, in step S110 according to the present disclosure, the telematics service system 120 receives the first vehicle data having the changed binary data from the vehicle terminal 110, when the vehicle data measured by the vehicle terminal 110 is changed into binary data.

Thereafter, in step S120 according to the present disclosure, the collection cycle is set and sent from a vehicle customer relationship management system 130 to the telematics service system 120. Then, the vehicle customer relationship management system 130 may receive the first vehicle data including the binary data from the telematics service system 120.

In order to extract abnormality from the received first vehicle data, in step S120 according to the present disclosure, the vehicle customer relationship management system 130 sets the abnormal condition with respect to the received first vehicle data and changes the predetermined collection cycle according to the abnormal condition when the abnormal condition is detected from the first vehicle data.

The changed collection cycle is referred to change collection cycle and means a cycle for extracting specific vehicle data necessary to determine abnormality such as vehicle malfunction. The change collection cycle is transmitted from the vehicle customer relationship management system 130 to the telematics service system 120.

In step S110 according to the present disclosure, the telematics service system 120 collects the second vehicle data extracted from the first vehicle data in correspondence with the change collection cycle received from the vehicle customer relationship system 130.

The collected second vehicle data may be retransmitted to the vehicle customer relationship management system 130. The second vehicle data may be binary data changed for increasing transmission efficiency, similarly to the first vehicle data.

In step S120 according to the present disclosure, the vehicle customer relationship management system 130 analyzes the second vehicle data received from the telematics service system 120 and signals the analyzed result to the manager terminal 140 and/or the user terminal 150 when vehicle abnormality continues. The analyzed result is preferably signaled in the form of a notification message.

In step S120 according to the present disclosure, as described above, the vehicle customer relationship management system 130 may set the changed collection cycle and the resolution of the collected second vehicle data to be greater than the unchanged collection cycle and the resolution of the first vehicle data. Preferably, the changed collection cycle and the resolution of the collected second vehicle data may be set to be greater than the unchanged collection cycle and the resolution of the first vehicle data. If the resolution of the vehicle data is changed, abnormality can be easily detected. The notification message generated according to the changed collection cycle and the resolution of the second vehicle data may be immediately transmitted to the manager terminal 140 and/or the user terminal 150.

In step S120 according to the present disclosure, the telematics service system 120 may receive the first vehicle data from the vehicle terminal 110 via a wireless network, when being connected with the vehicle terminal 100 over the wireless network. The wireless network may be one of various communication networks such as a mobile communication network and a local area network.

In step S120 according to the present disclosure, the telematics service system 120 may receive the second vehicle data from the vehicle terminal 110 over the wireless network when being connected with the vehicle terminal 100 over the wireless network. However, the second vehicle data is not received from the vehicle terminal 100 but is preferably extracted from the pre-collected first vehicle data in correspondence with the change collection cycle.

In the present embodiment, the collection cycle is set and is changed according to the abnormal condition if abnormality is detected upon collecting the vehicle data, vehicle data corresponding to abnormality is intensively collected, and abnormality is intensively analyzed, such that abnormality is more accurately detected from a vast amount of vehicle data and is signaled in an alarm form, thereby preventing vehicle accidents.

Hereinafter, the vehicle customer relationship management system 130 and the telematics service system 120 will be described in detail.

### Third Embodiment

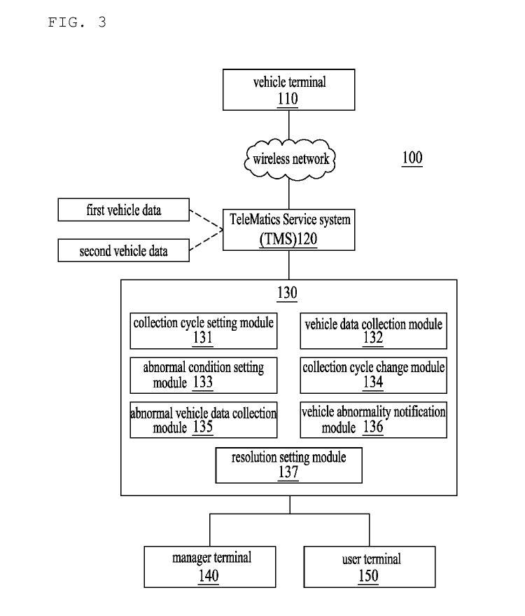

FIG. 3 is a diagram showing the configuration of a vehicle customer relationship management system 130 according to a third embodiment of the present disclosure in detail.

Referring to FIG. 3, the vehicle customer relationship management system 130 according to the third embodiment of the present disclosure includes a collection cycle setting module 131, a vehicle data collection module 132, an abnormal condition setting module 133, a collection cycle change module 134, an abnormal vehicle data collection module 135, a vehicle abnormality notification module 136 and a resolution setting module 137.

First, the vehicle customer relationship management system 130 according to the present disclosure sets the collection cycle with respect to the first vehicle data generated by the vehicle terminal 110. Then, the vehicle data collection module 132 collects the first vehicle data via at least one telematics service system (TMS) 120 according to the collection cycle set by the collection cycle setting module 131.

The collected first vehicle data may be binary data changed for increasing transmission efficiency. That is, the collection cycle setting module 131 according to the present disclosure receives the first vehicle data having the changed binary data from the vehicle terminal 110 via the at least one telematics service system 120, when the vehicle data measured by the vehicle terminal 110 is changed into the binary data.

Next, the abnormal condition setting module 133 according to the present disclosure sets the abnormal condition with respect to the first vehicle data collected by the collection cycle setting module 131. Then, the collection cycle change module 134 changes the collection cycle when the abnormal condition is detected from the collected first vehicle data. The collection cycle is changed in order to reduce the load of the collected first vehicle data to collect necessary vehicle data only.

Next, the abnormal vehicle data collection module 135 according to the present disclosure collects the second vehicle data from the vehicle terminal 110 or the at least one TMS 120 according to the collection cycle changed by the collection cycle setting module 131. The collected second vehicle data may be obtained by extracting only data having abnormality from the first vehicle data and may be binary data changed for increasing transmission efficiency, similarly to the first vehicle data.

Next, the vehicle abnormality notification module 136 according to the present disclosure analyzes the second vehicle data collected by the abnormal data collection module 135 and sends the analyzed result to the manager terminal 140 and/or the user terminal 150 when vehicle abnormality continues. The second vehicle data is sent to the manager terminal 140 and/or the user terminal 150 in the form of a notification message. Accordingly, a manager and a user can immediately check the abnormal state of the vehicle via the notification message.

Lastly, the resolution setting module 137 according to the present disclosure may set the changed collection cycle and the resolution of the collected second vehicle data to be greater than the unchanged collection cycle and the resolution of the first vehicle data, as described above. Preferably, the changed collection cycle and the resolution of the collected second vehicle data may be set to be greater than the unchanged collection cycle and the resolution of the first vehicle data. If the resolution of the vehicle data is changed, abnormality can be easily detected.

The notification message generated according to the changed collection cycle and the resolution of the second vehicle data may be immediately transmitted from the resolution setting module 137 to the manager terminal 140 and/or the user terminal 150.

In the present embodiment, the collection cycle is set and is changed according to the abnormal condition if abnormality is detected upon collecting the vehicle data, vehicle data corresponding to abnormality is intensively collected, and abnormality is intensively analyzed, such that abnormality is more accurately detected from a vast amount of vehicle data and is signaled in an alarm form, thereby preventing vehicle accidents.

### Fourth Embodiment

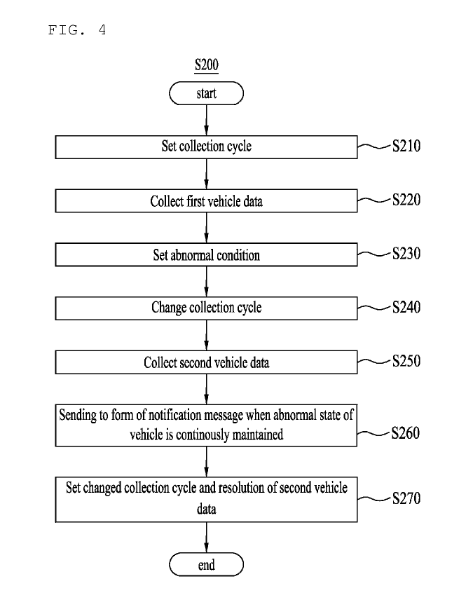

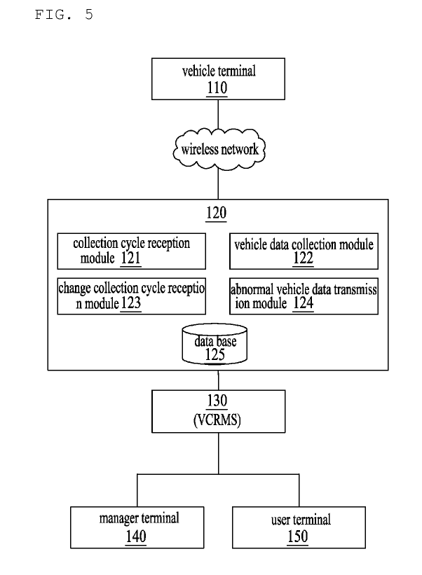

FIG. 4 is a flowchart illustrating a method 5200 of managing an abnormal state of a vehicle in a vehicle customer relationship management system 130 according to a third embodiment of the present disclosure.

Referring to FIG. 4, the method 5200 of managing the abnormal state of the vehicle in the vehicle customer relationship management system 130 according to the fourth embodiment of the present disclosure includes steps S210 to S270 in order to manage the abnormal state of the vehicle data.

First, in step S210 according to the present disclosure, the vehicle customer relationship management system 130 sets the collection cycle with respect to the first vehicle data generated by the vehicle terminal 110. Then, in step S220, the vehicle data collection module 132 collects the first vehicle data via at least one telematics service system (TMS) 120 according to the collection cycle set by the collection cycle setting module 131.

The collected first vehicle data may be binary data changed for increasing transmission efficiency. That is, in step S210 according to the present disclosure, the collection cycle setting module 131 receives the first vehicle data having the changed binary data from the vehicle terminal 110 via the at least one telematics service system 120, when the vehicle data measured by the vehicle terminal 110 is changed into binary data.

Next, in step S230 according to the present disclosure, the abnormal condition setting module 133 sets the abnormal condition with respect to the collected first vehicle data by step S210. Then, in step S240, the collection cycle change module 134 changes the collection cycle when the set abnormal condition is detected from the collected first vehicle data. The collection cycle is changed in order to reduce the load of the collected first vehicle data to collect necessary vehicle data only.

Next, in step S250 according to the present disclosure, the abnormal vehicle data collection module 135 collects the second vehicle data from the vehicle terminal 110 or the at least one TMS 120 according to the collection cycle changed in step S210. The collected second vehicle data may be obtained by extracting only data having abnormality from the first vehicle data and may be binary data changed for increasing transmission efficiency, similarly to the first vehicle data.

Next, in step S260 according to the present disclosure, the vehicle abnormality notification module 136 analyzes the second vehicle data collected in step S250 and sends the second vehicle data to the manager terminal 140 and/or the user terminal 150 when vehicle abnormality continues. The second vehicle data is preferably sent to the manager terminal 140 and/or the user terminal 150 in the form of a notification message. Accordingly, the manager and the user can immediately check the abnormal state of the vehicle via the notification message.

Lastly, in step S270 according to the present disclosure, the resolution setting module 137 may set the changed collection cycle and the resolution of the collected second vehicle data to be greater than the unchanged collection cycle and the resolution of the first vehicle data, as described above. Preferably, the changed collection cycle and the resolution of the collected second vehicle data may be set to be greater than the unchanged collection cycle and the resolution of the first vehicle data. If the resolution of the vehicle data is changed, abnormality can be easily detected. The notification message generated according to the changed collection cycle and the resolution of the second vehicle data may be immediately transmitted from the resolution setting module 137 to the manager terminal 140 and/or the user terminal 150.

In the present embodiment, the collection cycle is set and is changed according to the abnormal condition if abnormality is detected upon collecting the vehicle data, vehicle data corresponding to abnormality is intensively collected, and abnormality is intensively analyzed, such that abnormality is more accurately detected from a vast amount of vehicle data and is signaled in an alarm form, thereby preventing vehicle accidents.

### Fifth Embodiment

FIG. 5 is a diagram showing the configuration of a telematics service system 120 according to a fifth embodiment of the present disclosure in detail.

Referring to FIG. 5, the telematics service system 120 according to the fifth embodiment of the present disclosure includes a collection cycle reception module 121, a vehicle data reception module 122, a change collection cycle reception module 123, an abnormal vehicle data transmission module 124 and a database 125.

First, the collection cycle reception module 121 according to the present disclosure receives a collection cycle signal set with respect to the first vehicle data generated by the vehicle terminal 110 from the vehicle customer relationship management (VCRM) system 130.

Next, the vehicle data reception module 122 according to the present disclosure receives the first vehicle data from the vehicle terminal 110 in correspondence with the collection cycle signal received by the collection cycle reception module 121. The received first vehicle data may be binary data changed to increase transmission efficiency.

That is, the vehicle data reception module 122 according to the present disclosure receives the first vehicle data having the changed binary data from the vehicle terminal 110, when the vehicle data measured by the vehicle terminal 110 is changed into the binary data.

Next, the change collection cycle reception module 123 according to the present disclosure transmits the first vehicle data received by the vehicle data reception module 122 to the vehicle customer relationship management system 130 and receives a changed collection signal from the vehicle customer relationship management system 130 in correspondence with the abnormal condition generated in the first vehicle data. In other words, the vehicle customer relationship management system 130 changes the predetermined collection cycle according to the predetermined abnormal condition when abnormality is detected from the first vehicle data.

Accordingly, the changed collection cycle reception module 123 according to the present disclosure may receive the change collection signal from the vehicle customer relationship management system 130. The received change collection cycle means a cycle for extracting specific vehicle data necessary to determine abnormality such as vehicle malfunction.

Next, the abnormal vehicle data transmission module 124 according to the present disclosure receives the second vehicle data from the vehicle terminal 110 or extracts the second vehicle data from the first vehicle data in correspondence with the change collection signal received from the change collection cycle reception module 123. The extracted second vehicle data may be binary data changed for increasing transmission efficiency, similarly to the first vehicle data. The second vehicle data is transmitted to the vehicle customer relationship management system 130.

Lastly, the database 125 according to the present disclosure is responsible for storing the data processed by the collection cycle reception module 121, the vehicle data reception module 122 and the change collection cycle reception module 123 and the abnormal vehicle data transmission module 124.

The database 125 includes a narrow-sense database and a wide sense database capable of writing data based on a file system. A set of logs for retrieving and extracting data may be included in the database of the present disclosure.

### Sixth Embodiment

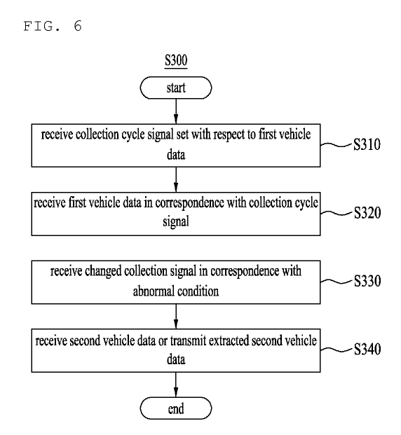

FIG. 6 is a flowchart illustrating a method 5300 of managing an abnormal state of a vehicle in a telematics service system 120 according to a sixth embodiment of the present disclosure.

Referring to FIG. 6, the method 5300 of managing the abnormal state of the vehicle in the telematics service system 120 according to the sixth embodiment of the present disclosure includes steps S310 to s340, in order to manage the abnormal state of the vehicle.

First, in step S310 according to the present disclosure, the collection cycle reception module 121 receives a collection cycle signal set with respect to the first vehicle data generated by the vehicle terminal 110 from the vehicle customer relationship management (VCRM) system 130.

Next, in step S310 according to the present disclosure, the vehicle data reception module 122 receives the first vehicle data from the vehicle terminal 110 in correspondence with the collection cycle signal received in step S310. The received first vehicle data may be binary data changed for increasing transmission efficiency.

That is, in step S320 according to the present disclosure, the vehicle data reception module 122 receives the first vehicle data having the changed binary data from the vehicle terminal 110, when the vehicle data measured by the vehicle terminal 110 is changed into binary data.

Next, in step S330 according to the present disclosure, the change collection cycle reception module 123 transmits the first vehicle data received by the vehicle data reception module 122 to the vehicle customer relationship management system 130 and receives a changed collection signal from the vehicle customer relationship management system 130 in correspondence with the abnormal condition generated in the first vehicle data. In other words, the vehicle customer relationship management system 130 changes the predetermined collection cycle according to the predetermined abnormal condition when abnormality is detected from the first vehicle data.

Accordingly, in step S330 according to the present disclosure, the change collection cycle reception module 123 may receive the change collection signal from the vehicle customer relationship management system 130. The received change collection cycle means a cycle for extracting specific vehicle data necessary to determine vehicle malfunction.

Next, in step S134 according to the present disclosure, the abnormal vehicle data transmission module 124 receives the second vehicle data from the vehicle terminal 110 or extracts the second vehicle data from the first vehicle data in correspondence with the change collection signal received in step 320.

The extracted second vehicle data may be binary data changed for increasing transmission efficiency, similarly to the first vehicle data. The second vehicle data is transmitted from the abnormal vehicle data transmission module 124 to the vehicle customer relationship management system 130.

In the present embodiment, the collection cycle is set and is changed according to the abnormal condition if abnormality is detected upon collecting the vehicle data, vehicle data corresponding to abnormality is intensively collected, and abnormality is intensively analyzed, such that abnormality is more accurately detected from a vast amount of vehicle data and is signaled in an alarm form, thereby preventing vehicle accidents.

The embodiments of the present disclosure are implemented in the form of a program command performed through various computer means so as to be recorded on a computer-readable medium. The computer-readable medium may include a program command, a data file, a data structure, or a combination thereof. The program command recorded on the medium may be specially designed and constructed for the present disclosure or may be known to and used by those skilled in computer software. Examples of the computer-readable recording medium include magnetic media such as a hard disk, a floppy disk or a magnetic tape, optical media such as a CD-ROM or a DVD, magneto-optical media such as a floptical disk, and a hardware device specially constructed to store and perform a program command, such as a ROM, a RAM or a flash memory. Examples of the program command include machine code generated by a compiler and a high-level language code executed by a computer using an interpreter. The hardware device may be constructed to be operated as one or more software modules in order to perform the operation of the present disclosure, and vice versa. It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

As described above, according to the present disclosure, a collection cycle is set and is changed according to an abnormal condition if abnormality is detected upon collecting vehicle data, vehicle data corresponding to abnormality is intensively collected, and abnormality is intensively analyzed. Therefore, it is possible to more accurately detect abnormality from a vast amount of vehicle data and to signal abnormality in an alarm form. Thus, it is possible to prevent vehicle accidents.

According to the present disclosure, by increasing resolution of vehicle data which is intensively analyzed, it is possible to more accurately perform analysis and abnormality detection.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A vehicle customer relationship management system comprising:
a collection cycle setting module configured to set a collection cycle with respect to first vehicle data generated by a vehicle terminal;
a vehicle data collection module configured to collect the generated first vehicle data via at least one telematics service system according to the set collection cycle;
an abnormal condition setting module configured to set an abnormal condition with respect to the collected first vehicle data;
a collection cycle change module configured to change the set collection cycle when the set abnormal condition is detected from the collected first vehicle data; and
an abnormal vehicle data collection module configured to collect second vehicle data from the vehicle terminal or the at least one telematics service system based on the changed collection cycle.

2. The vehicle customer relationship management system according to claim 1, further comprising a vehicle abnormality notification module configured to analyze the collected second vehicle data and transmit the analyzed data to a manager terminal or a user terminal in the form of a notification message when vehicle abnormality continues.

3. The vehicle customer relationship management system according to claim 2, further comprising a resolution setting module configured to set the changed collection cycle and a resolution of the second vehicle data to be greater than an unchanged collection cycle and a resolution of the first vehicle data.

4. The vehicle customer relationship management system according to claim 3, wherein the vehicle abnormality notification module is further configured to generate the notification message based on the set resolution.

5. The vehicle customer relationship management system according to claim 1, wherein the first vehicle data is binary data changed from measured data.

6. A telematics service system comprising:
a collection cycle reception module configured to receive a collection cycle signal set with respect to first vehicle data generated by a vehicle terminal from a vehicle customer relationship management (VCRM) system;
a vehicle data reception module configured to receive the generated first vehicle data from the vehicle terminal in correspondence with the set collection cycle signal;
a change collection cycle reception module configured to transmit the received first vehicle data to the VCRM system and receive a change collection signal changed in correspondence with an abnormal condition generated in a first vehicle from the VCRM system; and
an abnormal vehicle data transmission module configured to acquire second vehicle data by receiving the second vehicle data from the vehicle terminal in correspondence with the change collection signal or extracting the second vehicle data from the first vehicle data and transmit the second vehicle data to the VCRM system.

7. The telematics service system according to claim 6, wherein the second vehicle data is binary data selected and changed from the first vehicle data.

8. The telematics service system according to claim 7, wherein the vehicle data reception module is further configured to receive the first vehicle data from the vehicle terminal over a wireless network when connected with the vehicle terminal over the wireless network.

9. The telematics service system according to claim 8, wherein the abnormal vehicle data transmission module is further configured to receive the second vehicle data from the vehicle terminal over the wireless network when connected with the vehicle terminal over the wireless network.

10. A system for managing an abnormal state of a vehicle, the system comprising:
a telematics service system configured to collect first vehicle data generated by a vehicle terminal based on a predetermined collection cycle; and
a vehicle customer relationship management system configured to set the collection cycle, receive the collected first vehicle data from the telematics service system, set an abnormal condition with respect to the received first vehicle data, and change the set collection cycle.

11. The system according to claim 10, wherein, when the vehicle customer relationship management system transmits the changed collection cycle to the telematics service system, the telematics service system is further configured to collect second vehicle data extracted from the first vehicle data in correspondence with the changed collection cycle and transmit the second vehicle data to the vehicle customer relationship management system.

12. The system according to claim 11, wherein the vehicle customer relationship management system is further configured to analyze the collected second vehicle data and transmit the analyzed data to a manager terminal or a user terminal in the form of a notification message when vehicle abnormality continues.

13. The system according to claim 12, wherein the vehicle customer relationship management system is further configured to set the changed collection cycle and a resolution of the second vehicle data to be greater than an unchanged collection cycle and a resolution of the first vehicle data.

14. The system according to claim 13, wherein the vehicle customer relationship management system is further configured to generate the notification message based on the set resolution.

15. The system according to claim 11, wherein the telematics service system is further configured to receive the first vehicle data from the vehicle terminal over a wireless network when connected with the vehicle terminal over the wireless network.

16. The system according to claim 15, wherein the telematics service system is further configured to receive the second vehicle data from the vehicle terminal over the wireless network when connected with the vehicle terminal over the wireless network.

17. The system according to claim 10, wherein the first vehicle data is binary data changed from measured data.

18. A method of managing an abnormal state of vehicle data collected in a vehicle customer relationship management system, the method comprising:
setting, by a collection cycle setting module, a collection cycle with respect to first vehicle data generated by a vehicle terminal;
collecting, by a vehicle data collection module, the generated first vehicle data via at least one telematics service system based on the set collection cycle;
setting, by an abnormal condition setting module, an abnormal condition with respect to the collected first vehicle data;
changing, by a collection cycle change module, the set collection cycle when the set abnormal condition is detected from the first vehicle data; and
collecting, an abnormal vehicle data collection module, second vehicle data from the vehicle terminal or the at least one telematics service system based on the changed collection cycle.
